(19) United States
(12) Patent Application Publication
(10) Pub. No.: US 2018/0181791 A1
(43) Pub. Date: Jun. 28, 2018

(54) SPECTRAL SIGNATURE ASSISTED FINGER ASSOCIATED USER APPLICATION

(71) Applicant: Intel Corporation, Santa Clara, CA (US)

(72) Inventor: Mikko Kursula, Lempäälä (FI)

(21) Appl. No.: 15/393,128

(22) Filed: Dec. 28, 2016

(51) Int. Cl. G06K 9/00

(52) U.S. Cl. CPC G06K 9/00087; G06K 9/0004; G06K 2009/0006; G06K 9/00892; G06K 9/00906

(57) ABSTRACT

Apparatuses, methods and storage media associated with spectral signature assisted finger associated user applications are disclosed herein. In embodiments, an apparatus may comprise a light source to illuminate a potential finger with light that covers a plurality of wavelengths; and a sensor to capture a spectral signature of the potential finger. The spectral signature may span at least two of the plurality of wavelengths, and may be used to determine whether the potential finger is a human finger. Additionally, in embodiments, other finger data associated with the potential finger may be captured and used for finger associated user application, on determination that the potential finger is a human finger. Other embodiments may be disclosed or claimed.

### TECHNICAL FIELD

The present disclosure relates to the field of computing, in particular, to apparatuses, methods and storage media associated with spectral signature assisted finger associated user applications, such as, fingerprint based user authentication.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

With advances in technology, finger associated user applications are increasingly more common. For example, fingerprint sensors are becoming common in consumer and professional electronics, where fingerprint data collected by the sensors are used to authenticate the users. However, often times the sensors are not very reliable, i.e., the sensor can be fooled with simple fake finger pattern that is generated from photograph or by other means, which leads to compromised security or requiring difficult multi-phase authentication processes. In some devices, the fingerprint authentication security is improved by trying to detect finger tissue structures deeper than the skin surface.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1 and 2 respectively illustrate a cross-section view and a top view of a finger reader of the present disclosure, in accordance with various embodiments.

FIG. 3 illustrates a cross-section view of another finger reader of the present disclosure, in accordance with various embodiments.

FIG. 4 illustrates a cross-section view of still another finger reader of the present disclosure, in accordance with various embodiments.

FIG. 5 illustrates various example spectral signatures, in accordance with various embodiments.

FIG. 6 illustrates a process for spectral signature assisted finger associated user application, in accordance with various embodiments.

FIG. 7 illustrates an example computer system suitable for practicing aspects of the present disclosure, in accordance with various embodiments.

FIG. 8 illustrates an example storage medium with instructions configured to enable a computer system to practice the present disclosure, in accordance with various embodiments.

### DETAILED DESCRIPTION

Apparatuses, methods and storage media associated with spectral signature assisted finger associate user applications are disclosed herein. In embodiments, an apparatus (e.g., a finger reader) may comprise a light source to illuminate a potential finger with light that covers a plurality of wavelengths; and a sensor to capture a spectral signature of the potential finger. The spectral signature may span at least two of the plurality of wavelengths, and may be used to determine whether the potential finger is a human finger. Additionally, in embodiments, finger data associated with the potential finger (such as fingerprint data) may be captured (e.g., by the finger reader) and used (e.g., by a host system) for a finger related user application (e.g., fingerprint based user authentication), on determination that the potential finger is a human finger.

In the description to follow, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs generated from a plurality of programming instructions, a combinational logic circuit, and/or other suitable components that provide the described functionality.

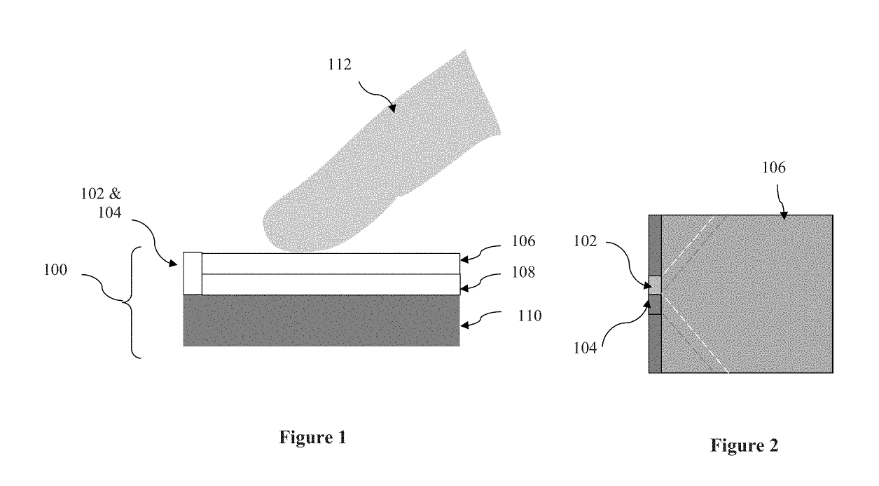

Referring now FIGS. 1 and 2, wherein a cross-section view and a top view of a finger reader of the present disclosure, in accordance with various embodiments, are shown. As illustrated, in embodiments, finger reader 100 may include a light source 102, a spectral sensor 104, and an array of other sensors 108. Array of other sensors 108 may be disposed on top of substrate 110. Additionally, finger reader 100 may include glass surface 106 disposed on top of array of other sensors 108, with light source 102 and spectral sensor 104 disposed at a side of glass surface 106 and other sensors 108.

Light source 102 may be configured to provide light with a plurality of wavelengths to illuminate potential finger 112. In embodiments, light source 102 may be configured to provide light that cover the entire spectrum from infrared to near ultra-violet. In embodiments, light source 102 may be a single white light emitting diode (LED). In alternate embodiments, light source 102 may comprise an array of different wavelength LEDs.

Spectral sensor 104 may be configured to capture a spectral signature of potential finger 112, based at least in part on the light reflected off potential finger 112. The spectral signature may span at least two of the plurality of wavelengths. The multi-wavelength spectral signature may enable a determination to be made on the constituting material of potential finger 112. In turn, the result of the material determination may enable a determination to be made on whether potential finger 112 is a non-human fabricated finger, e.g., a non-human fabricated finger that is part of an attempt to spoof a host system (e.g., computer system 700 of FIG. 7) of finger reader 100. In embodiments, the spectral signature may be a hyperspectral signature that spans the entire spectrum from infrared to near ultra-violet. In other words, spectral sensor 104 may be a hyperspectral sensor.

In embodiments, spectral sensor 104 may be a single pixel or a multi-pixel sensor. In some multi-pixel embodiments, each pixel sensing element may be configured to sense light of a particular wavelength. In other embodiments, spectral sensor 104 may be configured with adjustable wavelength narrow band optical filter to allow a pixel sensing element be used to sense light of different wavelengths. For example, the filter may be a micro-electro-mechanical system (MEMS) based Fabry-Perot Interferometer. Thus, spectral sensor 104 allows data associated with the spectral signature of potential finger 112 to be collected at each optical wavelength of interest. Together, the collected data enables the spectral signature of potential finger 112 be constructed. In embodiments, spectral sensor 104 may be a camera having hundreds, thousands, tens of thousands or more pixel sensing elements.

For the illustrated embodiments, spectral sensor 104 may sense the lights reflected off potential finger 112 as well as reflected off array of other sensors 108. Since the reflection off array of other sensors 108 may be pre-determined, the reflection off array of other sensors 108 may be factored into consideration, subtracted from the reflection sensed by spectral sensor 104.

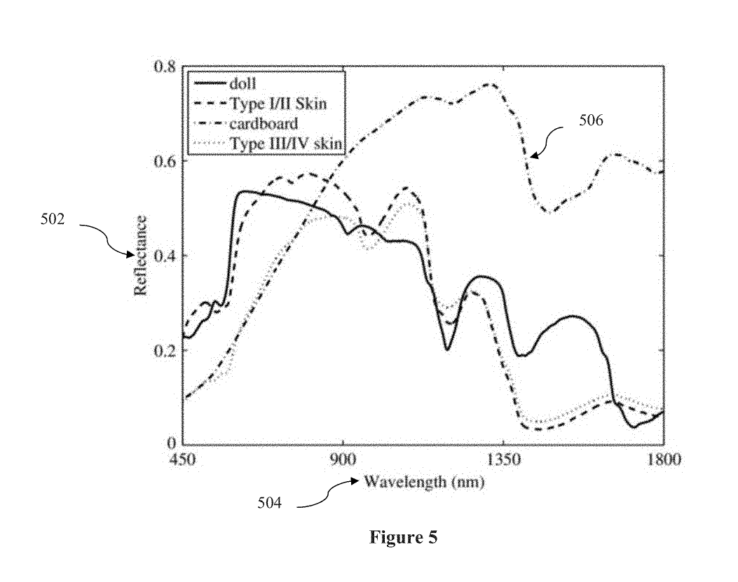

FIG. 5 illustrates various example spectral signatures, in accordance with various embodiments. Each signature 506 shows the amount of reflectance 502 of a material for various wavelengths 504. Four example spectral signatures 506, one each for an example doll, Type I/II skin, cardboard, and Type III/IV skin are shown. Thus, it can be seen different materials have different spectral signatures that may be pre-determined and stored as reference spectral signatures. In particular, it is known that human skin typically include chemicals such as collagen, elastin, keratin, various oils and fats, melanin and so forth. The skin spectral response represents a combination of the spectral responses of all these typical chemicals found on human skin. On doing so, comparison of a collected spectral signature of potential finger 112 with the stored reference spectral signatures may enable the material of potential finger 112 be determined.

Referring to FIG. 1 again, array of other sensors 108 may be configured to capture other finger data associated with potential finger 112, e.g., fingerprint data associated with potential finger 112 for fingerprint based user authentication. In other words, for these embodiments, array of other sensors 108 may be array of fingerprint sensors. In other embodiments, array of other sensors 108 may be configured to capture other finger data associated with potential finger 112 for other finger associated user applications, such as pulse oximetry measurement, blood glucose level measurements, or for other biological sensing related applications where the measurements are performed on the finger skin. In general, sensors of array of other sensors 108 may be any one of a number of the sensors known in the art for the respective finger associated user applications. Similarly, substrate 110 and glass surface 106 may be constituted with any one of a number of suitable materials known in the art.

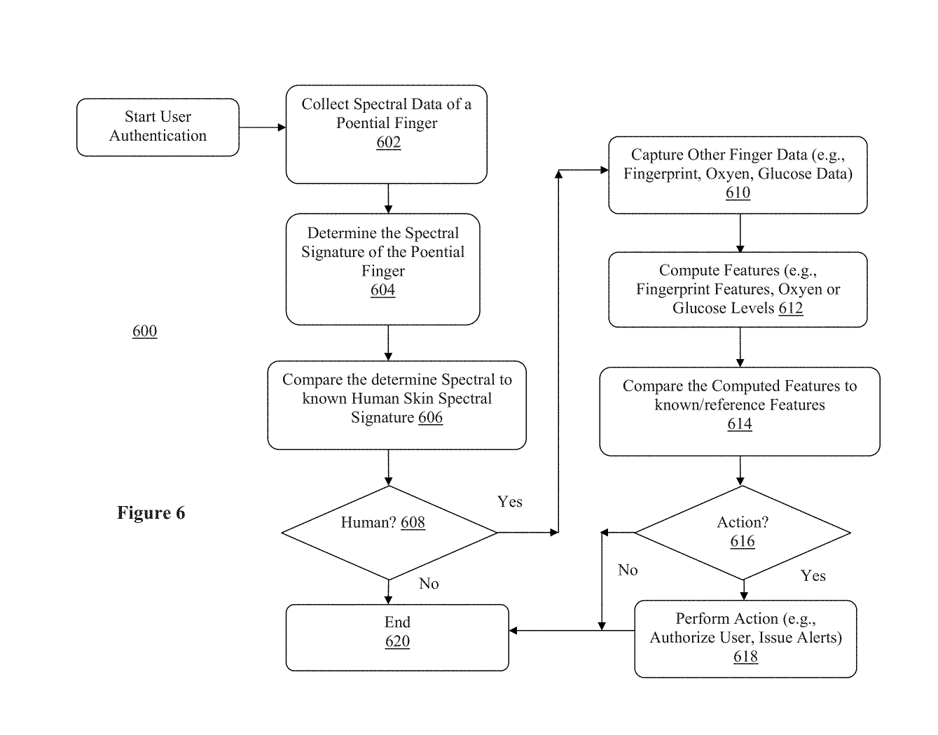

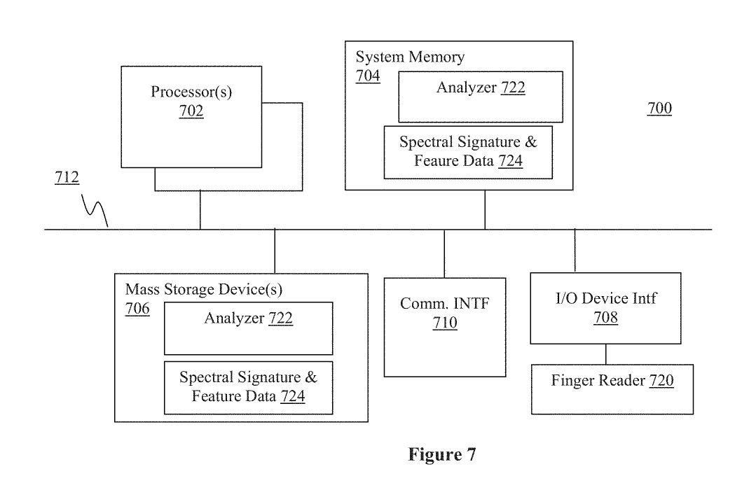

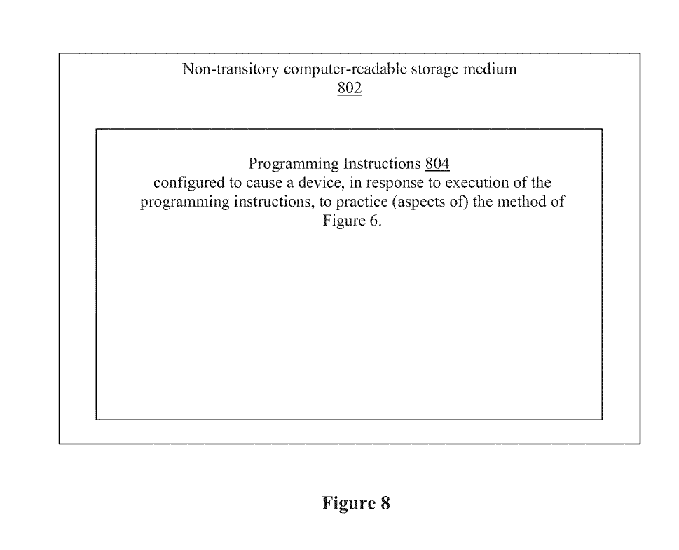

In operation of the fingerprint based user authentication embodiments, the captured spectral signature and the fingerprint data may be employed by an user authentication function of a host system of finger reader 100 to authenticate a user. In particular, the captured spectral signature may be employed to determine whether potential finger 112 is a human finger. Only on determination that potential finger 112 is a human finger, the fingerprint data are employed by the user authentication function of the host system to authenticate the user. Resultantly, the risk of being spoofed with fabricated fingerprint data may be reduced. An example process for spectral signature assisted finger associated user application, suitable for fingerprint based user authentication, will be described with further details later, with references to FIG. 6.

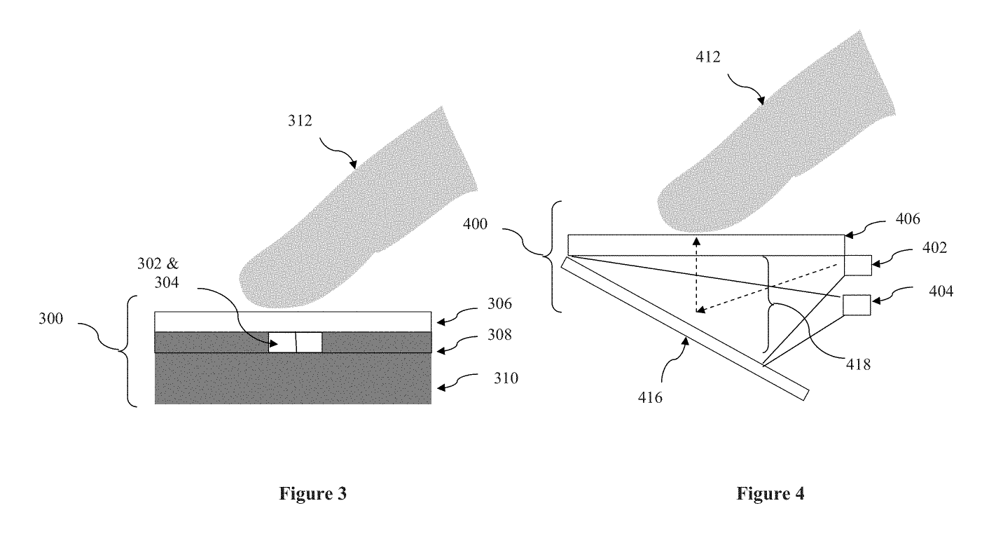

Referring now to FIG. 3, wherein a cross-section view of another finger reader of the present disclosure, in accordance with various embodiments, is shown. Similar to finger reader 100, finger reader 300 may include light source 302, spectral sensor 304, array of other sensors 308, glass surface 306 and substrate 310. Array of other sensors 308, glass surface 306 and substrate 310 are similarly arranged, except light source 302 and spectral sensor 304 are disposed at center of the plane where array of other sensors 308 are arranged. Like spectral sensor 104, spectral sensor 304 may be a single pixel or a multi-pixel sensor. The sensing elements of a multi-pixel sensor may be configured to sense light of a particular wavelength. Spectral sensor 304 may also be configured with adjustable wavelength narrow band optical filter to allow a sensing element to sense light of multiple wavelengths. Spectral sensor 304 may also be a camera with hundred, thousands, tens of thousands or more pixels. Similarly, the constitution and functions of light source 302, array of other sensors 308, glass surface 306 and substrate 310 are similar to light source 102, array of other sensors 108, glass surface 106 and substrate 110.

Referring now to FIG. 4, wherein a cross-section view of still another finger reader of the present disclosure, in accordance with various embodiments, is shown. Similar to finger readers 100 and 300, finger reader 400 may include light source 402 and glass surface 406. However, in lieu of spectral sensor 104/304, array of other sensors 108/308, and substrate 110/310, a camera 404 and a mirror 416 are provided. Mirror 416 is angularly disposed relative to glass surface 406 defining angular opening 418. Light source 402 and camera 404 are located at the mouth of angular opening 418. Similar to light sources 102 and 302, light source 402 may be configured to provide light with a plurality of wavelengths, e.g., full spectrum light, to illuminate potential finger 412, via mirror 416 (as illustrated by the dotted arrows). Camera 404 may be configured to capture one or more images of potential finger 412. For these embodiments, the captured images may be used to determine the spectral signature of potential finger 412 to determine whether it is a human finger, as well as to extract other finger data (such as fingerprint data for authentication), on determining that potential finger 412 is a human finger. Otherwise, the constitution and functions of light source 402 and glass surface 406 are similar to light sources 102 and 302, and glass surface 106 and 306.

Referring now to FIG. 6, wherein a process for spectral signature assisted finger related user application, in accordance with various embodiments, is illustrated. As shown, process 600 for spectral signature assisted finger related user application may comprise of operations performed at blocks 602-620. In embodiments, the operations at blocks 602-620 may be performed using any one of finger readers 100, 300 and 400, in conjunction with analyzer 722 (FIG. 7). The operations in blocks 602-620 are presented in a manner and order for ease of understanding. In alternate embodiments, the operations may be performed in different order, combined or split.

Process 600 may start at block 602. At block 602, spectral data associated with the spectral signature of a potential finger for a plurality of wavelengths may be captured. In embodiments, the spectral data may be captured using lights with a plurality of wavelengths, e.g., full spectrum light with wavelengths from infrared to near ultra-violet. Next, at block 602, a spectral signature of the potential finger may be determined, using the spectral data.

At block 606, the determined spectral signature may be compared to known human skin spectral signature(s). At block 606, a determination may be made on whether a result of the comparison in block 606 indicates the determined spectral signature substantially matches at least one known human skin spectral signature. If the determined spectral signature does not substantially match any known human skin spectral signature (no branch of 608), the potential finger may be considered a non-human finger, i.e., a fabricated finger that is part of an attempt to spoof the finger reader. At such point, process 600 may proceed to block 620, and terminate the user authentication process. However, if the determined spectral signature does substantially match a known human skin spectral signature (yes branch at 608), the potential finger may be considered a human finger, and process 600 may continue at block 610.

In alternate embodiments, the determined spectral signature of the potential finger may be compared to known spectral signatures of non-human materials. Process 600 may proceed to block 620 and terminate the finger associated user application process on determining that the determined spectral signature of the potential finger matches a known spectral signature of a non-human material.

At block 610, other finger data associated with the human finger (e.g., fingerprint, oxygen or glucose data) may be collected. In alternate embodiments, the other finger data may be collected in parallel with or combined with the operations for capturing of the spectral data of the potential finger in block 602. Next, at block 612, features of the human finger associated with the finger associated user application (such as fingerprint features, oxygen or glucose level) may be computed, using the other finger data.

At block 614, the computed features (e.g., fingerprint features, oxygen or glucose levels) may be compared to known/reference features (e.g., fingerprint features of one or more authorized users, or normal oxygen/glucose ranges for users of particular demographic or age groups). At block 616, a determination may be made to take an action based on a result of the comparison. For example, for fingerprint based user authentication embodiments, a determination may be made on whether a result of the comparison in block 614 indicates the computed fingerprint features substantially match known fingerprint features of authorized users. If the computed fingerprint features do not substantially match fingerprint features of any authorized user (no branch of 608), the human finger may be considered as belonging to an unauthorized user, part of an attempt to gain unauthorized access of the host system. At such point, process 600 may proceed to block 620, and terminate the process. However, if the computed fingerprint features do substantially match known fingerprint features of an authorized user (yes branch at 608), process 600 may continue at block 618. At block 618, the user presenting the human finger may be authenticated and access be granted to the host system of the fingerprint printer. Thereafter, process 600 may terminate.

For other finger associated user applications, e.g., pulse oximetry or blood glucose measurement, at block 614, the computed oxygen or glucose level may be compared against reference ranges. At block 616, a determination may be made on whether to issue an alert based on a result of the comparison. For example, if a result of the comparison in block 614 indicates the computed oxygen or glucose level does not substantially exceed an applicable reference range (no branch of 608), process 600 may proceed to block 620, and terminate the process. However, if the computed oxygen or glucose level does exceed an applicable reference range (yes branch at 608), process 600 may continue at block 618. At block 618, an alert or warning to the user or to a physician or nurse of the user may be provided. Thereafter, process 600 may terminate.

Referring now to FIG. 7, wherein a block diagram of a computer device suitable for practice aspects of the present disclosure, in accordance with various embodiments, is illustrated. As shown, computer device 700 may include one or more processors 702 and system memory 704. Each processor 702 may include one or more processor cores. System memory 704 may include any known volatile or non-volatile memory.

Additionally, computer device 700 may include mass storage device(s) 706 (such as solid state drives), input/output device interface 708 (to interface with various components, such as finger reader 720, which may be one of finger readers 100, 300 and 400) and communication interfaces 610 (such as network interface cards, modems and so forth). In embodiments, communication interfaces 710 may support wired or wireless communication, including near field communication. The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage device(s) 706 may be employed to store a working copy and a permanent copy of the executable code of the programming instructions implementing the operations described earlier, e.g., but not limited to, operations associated with determining spectral signature, computing finger features (such as fingerprint features, oxygen or glucose levels, and so forth), and comparing the computed spectral signature/features to known spectral signatures and reference features, collectively referred to as analyzer 722. In fingerprint based user authentication embodiments, analyzer 722 may comprise fingerprint based authentication logic. The programming instructions may comprise assembler instructions supported by processor(s) 702 or high-level languages, such as, for example, C, that can be compiled into such instructions. In embodiments, system memory 704 and mass storage device(s) 706 may also be employed to store a working copy and a permanent copy of various working or reference data 724, such as, the computed spectral signature, the reference/known spectral signatures of known materials/human skin, fingerprint features of authorized users, oxygen or glucose ranges of various demographic/age groups.

The permanent copy of the executable code of the programming instructions and the may be placed into permanent mass storage device(s) 706 in the factory, or in the field, through, for example, a distribution medium (not shown), such as a compact disc (CD), or through communication interface 710 (from a distribution server (not shown)).

The number, capability and/or capacity of these elements 710-712 may vary, depending on the intended use of example computer device 700, e.g., whether example computer device 700 is a wearable device, a smartphone, a tablet, an ultrabook, a laptop, a game console, a set-top box, or a vehicle infotainment system. The constitutions of these elements 710-712 are otherwise known, and accordingly will not be further described.

FIG. 8 illustrates an example non-transitory computer-readable storage medium having instructions configured to practice all or selected ones of the operations associated with the spectral signature assisted finger associated user application, earlier described, in accordance with various embodiments. As illustrated, non-transitory computer-readable storage medium 802 may include the executable code of a number of programming instructions 804, and reference/known spectral signatures of various materials, and reference/known finger features (such as oxygen/glucose ranges of various demographics or age groups). Executable code of programming instructions 804 may be configured to enable a device, e.g., computer device 700, in response to execution of the executable code/programming instructions, to perform, e.g., various operations associated with determining spectral signatures, computing finger features, and comparing both to known/reference spectral signatures of materials and known/reference finger features, described with references to FIGS. 1-6. In alternate embodiments, executable code/programming instructions 804 may be disposed on multiple non-transitory computer-readable storage medium 802 instead. In still other embodiments, executable code/programming instructions 804 may be encoded in transitory computer readable medium, such as signals.

Referring back to FIG. 7, for one embodiment, at least one of processors 702 may be packaged together with a computer-readable storage medium having some or all of analyzer 722 (in lieu of storing in system memory 704 and/or mass storage device 706) configured to practice all or selected ones of the operations earlier described with references to FIG. 1-6. For one embodiment, at least one of processors 702 may be packaged together with a computer-readable storage medium having some or all of analyzer 722 to form a System in Package (SiP). For one embodiment, at least one of processors 702 may be integrated on the same die with a computer-readable storage medium having some or all of analyzer 722. For one embodiment, at least one of processors 702 may be packaged together with a computer-readable storage medium having some or all of analyzer 722 to form a System on Chip (SoC). For at least one embodiment, the SoC may be utilized in, e.g., but not limited to, a hybrid computing tablet/laptop.

Thus an improved apparatus, method and storage medium associated with spectral signature assisted finger associated user application has been described.

Example 1 may be an apparatus for performing a finger associated user application, comprising: a light source to illuminate a potential finger with light that covers a plurality of wavelengths; and a sensor to capture a spectral signature of the potential finger; wherein the spectral signature spans at least two of the plurality of wavelengths, and is used to determine whether the potential finger is a human finger, and performance of the finger associated user application is conditioned on a determination that the potential finger is a human finger.

Example 2 may be example 1, wherein the plurality of wavelengths may span an entire electromagnetic spectrum from infrared to near-ultraviolet; the sensor may be a hyperspectral sensor; and the spectral signature may be a hyperspectral signature.

Example 3 may be example 1, wherein the sensor may comprise one or more sensing elements, with each sensing elements to sensing light of a particular wavelength.

Example 4 may be example 1, wherein the sensor may include an adjustable wavelength narrow band optical filter.

Example 5 may be example 1, wherein the sensor is a first sensor, and the apparatus may further comprise a second plurality of sensors to capture other finger associated data from the potential finger for the finger associated user application.

Example 6 may be example 5, wherein the second plurality of sensors may be arranged in an array configuration on a plane; the apparatus may further comprise a glass surface on top of the array of second plurality of sensors; and the light source and the first sensor are disposed at an edge of the glass surface and the array of second plurality of sensors.

Example 7 may be example 5, wherein the second plurality of sensors are arranged in an array configuration on a plane; the apparatus may further comprise a glass surface on top of the array of second plurality of sensors; and the light source and the first sensor are disposed at a center of the array of second plurality of sensors, underneath the glass surface.

Example 8 may be example 1, wherein the sensor may be a camera, and the camera may capture one or more images of the potential finger to provide the spectral signature as well as finger associated data of the potential finger for the finger associated user application.

Example 9 may be example 8 further comprising a glass surface and a mirror that defines an angular opening, wherein the light source and the camera may be proximately disposed at a mouth of the angular opening.

Example 10 may be any one of examples 1-9, further comprising an analyzer to analyze the spectral signature to determine whether the potential finger is a human finger.

Example 11 may be example 10, wherein the analyzer may analyze the spectral signature to determine whether the potential finger is a human finger by comparison of the spectral signature with a plurality of spectral signatures of a plurality of materials.

Example 12 may be example 10, wherein the finger associated user application may comprise fingerprint based user authentication, and the analyzer may further analyze fingerprint data associated with the potential finger, on determination that the potential finger is a human finger.

Example 13 may be example 10, wherein the finger associated user application may comprise a selected one of pulse oximetry measurement or blood glucose level measurement, and the analyzer may further analyze pulse oximetry or blood glucose level data associated with the potential finger, on determination that the potential finger is a human finger.

Example 14 may be a method for performing a finger associated user application, comprising: illuminating a potential finger with light that covers a plurality of wavelengths; capturing a spectral signature of the potential finger, wherein the spectral signature spans at least two of the plurality of wavelengths; and analyzing the spectral signature to determine whether the potential finger is a human finger; wherein performance of the finger associated user application is conditioned on a determination that the potential finger is a human finger.

Example 15 may be example 14, wherein the plurality of wavelengths span an entire electromagnetic spectrum from infrared to near-ultraviolet; and capturing may comprise capturing a hyperspectral signature.

Example 16 may be example 14, wherein analyzing may comprise comparing the spectral signature with a plurality of spectral signatures of a plurality of materials.

Example 17 may be example 14, further comprise capturing other finger associated data from the potential finger for the finger associated user application.

Example 18 may be any one of examples 14-17, wherein the finger associated user application may comprise fingerprint based user authentication, and analyzing may further comprise analyzing fingerprint data associated with the potential finger, on determination that the potential finger is a human finger.

Example 19 may be any one of examples 14-17, wherein the finger associated user application may comprise a selected one of pulse oximetry measurement or blood glucose level measurement, and analyzing may further comprise analyzing pulse oximetry or blood glucose level data associated with the potential finger, on determination that the potential finger is a human finger.

Example 20 may be at least one computer readable media (CRM) comprising a plurality of instructions configured to cause a computer device, in response to execution of the instructions, to: receive a spectral signature of a potential finger; and analyze the spectral signature of a potential finger to determine whether the potential finger is a human finger; wherein a performance of a finger associated user application by the computing device is conditioned on a determination that the potential finger is a human finger.

Example 21 may be example 20, wherein to receive a spectral signature may comprise to receive a hyperspectral signature that spans a plurality of wavelengths of an entire electromagnetic spectrum, from infrared to near-ultraviolet.

Example 22 may be example 20, wherein to analyze may comprise to compare the spectral signature with a plurality of spectral signatures of a plurality of materials.

Example 23 may be any one of examples 20-22, wherein the computer device is further caused to receive other finger associated data of the potential finger for the finger associated user application.

Example 24 may be example 23, wherein the finger associated user application may comprise fingerprint based user authentication, the other finger associated data may comprise fingerprint data of the potential finger, and to analyze may further comprise to analyze the fingerprint data associated with the potential finger, on determination that the potential finger is a human finger.

Example 25 may be example 23, wherein the finger associated user application may comprise a selected one of pulse oximetry measurement or blood glucose level measurement, the other finger associated data may comprise pulse oximetry or blood glucose level data associated with the potential finger. and to analyze may further comprise to analyze pulse oximetry or blood glucose level data associated with the potential finger, on determination that the potential finger is a human finger.

Example 26 may be an apparatus for performing a finger associated user application, comprising: means for illuminating a potential finger with light that covers a plurality of wavelengths; means for capturing a spectral signature of the potential finger, wherein the spectral signature spans at least two of the plurality of wavelengths; and means for analyzing the spectral signature to determine whether the potential finger is a human finger; wherein performance of the finger associated user application is conditioned on a determination that the potential finger is a human finger.

Example 27 may be example 26, wherein the plurality of wavelengths span an entire electromagnetic spectrum from infrared to near-ultraviolet; and means for capturing may comprise means for capturing a hyperspectral signature.

Example 28 may be example 26, wherein analyzing may comprise comparing the spectral signature with a plurality of spectral signatures of a plurality of materials.

Example 29 may be example 26, further comprising capturing other finger associated data from the potential finger for the finger associated user application.

Example 30 may be any one of examples 26-29, wherein the finger associated user application may comprise fingerprint based user authentication, and the apparatus may further comprise means for analyzing fingerprint data associated with the potential finger, on determination that the potential finger is a human finger.

Example 31 may be any one of examples 26-29, wherein the finger associated user application may comprise a selected one of pulse oximetry measurement or blood glucose level measurement, and the apparatus may further comprise means for analyzing pulse oximetry or blood glucose level data associated with the potential finger, on determination that the potential finger is a human finger.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for performing a finger associated user application, comprising:
a light source to illuminate a potential finger with light that covers a plurality of wavelengths; and
a sensor to capture a spectral signature of the potential finger;
wherein the spectral signature spans at least two of the plurality of wavelengths, and is used to determine whether the potential finger is a human finger, and performance of the finger associated user application is conditioned on a determination that the potential finger is a human finger.

2. The apparatus of claim 1, wherein the plurality of wavelengths span an entire electromagnetic spectrum from infrared to near-ultraviolet; the sensor is a hyperspectral sensor; and the spectral signature is a hyperspectral signature.

3. The apparatus of claim 1, wherein the sensor comprises one or more sensing elements, with each sensing elements to sensing light of a particular wavelength.

4. The apparatus of claim 1, wherein the sensor includes an adjustable wavelength narrow band optical filter.

5. The apparatus of claim 1, wherein the sensor is a first sensor, and the apparatus further comprising a second plurality of sensors to capture other finger associated data from the potential finger for the finger associated user application.

6. The apparatus of claim 5, wherein the second plurality of sensors are arranged in an array configuration on a plane; the apparatus further comprises a glass surface on top of the array of second plurality of sensors; and the light source and the first sensor are disposed at an edge of the glass surface and the array of second plurality of sensors.

7. The apparatus of claim 5, wherein the second plurality of sensors are arranged in an array configuration on a plane; the apparatus further comprises a glass surface on top of the array of second plurality of sensors; and the light source and the first sensor are disposed at a center of the array of second plurality of sensors, underneath the glass surface.

8. The apparatus of claim 1, wherein the sensor is a camera, and the camera is to capture one or more images of the potential finger to provide the spectral signature as well as finger associated data of the potential finger for the finger associated user application.

9. The apparatus of claim 8 further comprising a glass surface and a mirror that defines an angular opening, wherein the light source and the camera are proximately disposed at a mouth of the angular opening.

10. The apparatus of claim 1, further comprising an analyzer to analyze the spectral signature to determine whether the potential finger is a human finger.

11. The apparatus of claim 10, wherein the analyzer is to analyze the spectral signature to determine whether the potential finger is a human finger by comparison of the spectral signature with a plurality of spectral signatures of a plurality of materials.

12. The apparatus of claim 10, wherein the finger associated user application comprises fingerprint based user authentication, and the analyzer is to further analyze fingerprint data associated with the potential finger, on determination that the potential finger is a human finger.

13. The apparatus of claim 10, wherein the finger associated user application comprises a selected one of pulse oximetry measurement or blood glucose level measurement, and the analyzer is to further analyze pulse oximetry or blood glucose level data associated with the potential finger, on determination that the potential finger is a human finger.

14. A method for performing a finger associated user application, comprising:
illuminating a potential finger with light that covers a plurality of wavelengths;
capturing a spectral signature of the potential finger, wherein the spectral signature spans at least two of the plurality of wavelengths; and
analyzing the spectral signature to determine whether the potential finger is a human finger;
wherein performance of the finger associated user application is conditioned on a determination that the potential finger is a human finger.

15. The method of claim 14, wherein the plurality of wavelengths span an entire electromagnetic spectrum from infrared to near-ultraviolet; and capturing comprises capturing a hyperspectral signature.

16. The method of claim 14, wherein analyzing comprises comparing the spectral signature with a plurality of spectral signatures of a plurality of materials.

17. The method of claim 14, further comprising capturing other finger associated data from the potential finger for the finger associated user application.

18. The method claim 14, wherein the finger associated user application comprises fingerprint based user authentication, and analyzing further comprises analyzing fingerprint data associated with the potential finger, on determination that the potential finger is a human finger.

19. The method of claim 14, wherein the finger associated user application comprises a selected one of pulse oximetry measurement or blood glucose level measurement, and analyzing further comprises analyzing pulse oximetry or blood glucose level data associated with the potential finger, on determination that the potential finger is a human finger.

20. At least one computer readable media (CRM) comprising a plurality of instructions configured to cause a computer device, in response to execution of the instructions, to:
receive a spectral signature of a potential finger; and
analyze the spectral signature of a potential finger to determine whether the potential finger is a human finger;
wherein a performance of a finger associated user application by the computing device is conditioned on a determination that the potential finger is a human finger.

21. The CRM of claim 20, wherein to receive a spectral signature comprises to receive a hyperspectral signature that spans a plurality of wavelengths of an entire electromagnetic spectrum, from infrared to near-ultraviolet.

22. The CRM of claim 20, wherein to analyze comprises to compare the spectral signature with a plurality of spectral signatures of a plurality of materials.

23. The CRM of claim 20, wherein the computer device is further caused to receive other finger associated data of the potential finger for the finger associated user application.

24. The CRM of claim 23, wherein the finger associated user application comprises fingerprint based user authentication, the other finger associated data comprises fingerprint data of the potential finger, and to analyze further comprises to analyze the fingerprint data associated with the potential finger, on determination that the potential finger is a human finger.

25. The CRM of claim 23, wherein the finger associated user application comprises a selected one of pulse oximetry measurement or blood glucose level measurement, the other finger associated data comprises pulse oximetry or blood glucose level data associated with the potential finger. and to analyze further comprises to analyze pulse oximetry or blood glucose level data associated with the potential finger, on determination that the potential finger is a human finger.
